(19) United States
(12) Patent Application Publication
(10) Pub. No.: US 2010/0058221 A1
(43) Pub. Date: Mar. 4, 2010

(54) COMMODITY SALES DATA PROCESSING APPARATUS AND COMPUTER READABLE MEDIUM HAVING RECORDED THEREON COMPUTER PROGRAM FOR COMMODITY SALES DATA PROCESSING APPARATUS

(75) Inventors: Yumiko Okuma, Tokyo (JP); Maki Sato, Kanagawa (JP); Nobuhiro Sugita, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/552,745

(22) Filed: Sep. 2, 2009

(30) Foreign Application Priority Data
Sep. 4, 2008 (JP) 2008-227658

(51) Int. Cl. G06F 3/048

(52) U.S. Cl. 715/781; 715/808

(57) ABSTRACT

A display unit configured to display information and an input unit configured to input a number and an operator are provided. An area-display processing unit displays a main area and a sub-area on the display unit. A first display processing unit displays a first number and an operator input by the input unit in the main area in order of the input. A second display processing unit moves, when it is determined that a second number is input following an operator by the input unit, the first number and the operator displayed in the main area to the sub-area, displays the first number and the operator in the sub-area and, displays the input second number in the main area.

### CROSS REFERENCE TO RELATED APPLICATION

The present application is based on Japanese Priority Document P2008-227658 filed on Sep. 4, 2008, the content of which is incorporated herein by reference.

### TECHNICAL FIELD

The present invention relates to a commodity sales data processing apparatus such as a POS terminal installed in a store such as a supermarket and a computer-readable medium having recorded thereon a computer program for the commodity sales data processing apparatus.

### BACKGROUND

In general, a POS terminal installed in a store such as a supermarket includes a ten key (a keyboard or a touch panel). A barcode scanner is connected to the POS terminal. An operator of the POS terminal operates the ten key and the barcode scanner in a transaction. Information such as commodity codes and quantities is input to the POS terminal according to the operation in the ten key and the barcode scanner. A microcomputer of the POS terminal executes commodity sales data processing on the basis of the input commodity codes, quantities, and the like.

An example of operation of the POS terminal performed by the operator is explained.

First, it is assumed that only one commodity attached with a commodity code is stored in a shopping basket carried to a counter by a customer. In this case, the operator performs only operation for reading the commodity code attached to the commodity with the barcode scanner and does not perform depressing operation for the ten key.

Next, it is assumed that two or more commodities attached with the same commodity code are stored in a shopping basket. In this case, the operator performs operation for depressing the ten key and inputting quantities besides operation for reading the commodity code attached to the commodities with the barcode scanner. For example, when the same three commodities are stored in the shopping basket, as one procedure, after depressing the ten key in order of “3” and “×”, the operator cause the barcode scanner to read a commodity code and inputs the commodity code to the POS terminal. In this case, a series of input of “3”, “×”, and “commodity code” is decided with the input of the commodity code. The POS terminal displays information “the quantity of commodities=3” on a display device or the like.

For example, when the operator intends to input “3”, “×”, and “commodity code” in this order, the operator may forget to depress a key for inputting an operator for multiplication “×” by mistake. In this case, the POS terminal cannot decide the series of input “3”, “×”, and “commodity code” and does not display the information “the quantity of commodities=3” on the display device. Therefore, it is not until the information “the quantity of commodities=3” is displayed on the display device that the operator notices that the operator forgets to input “×”. Therefore, if the operator can notice the input mistake earlier at a stage of the input, the operator can promptly perform a transaction.

The inventor of this application performed a prior art search from a viewpoint of an input mistake in a commodity sales data processing apparatus and found JP-A-2003-228769. The technique disclosed in JP-A-2003-228769 is a technique for displaying an input quantity of commodities (number of commodities) to allow an operator to check the quantity. Therefore, the technique does not allow the operator to find an input mistake earlier in an input process.

### SUMMARY

It is an object of the present invention to allow an operator, who operates a commodity sales data processing apparatus such as a POS terminal, to find an input mistake earlier.

According to an aspect of the present invention, there is provided a commodity sales data processing apparatus including: a display unit configured to display information; an input unit configured to input a number and an operator; an area-display processing unit configured to display a main area and a sub-area on the display unit; a first display processing unit configured to display a first number and an operator input by the input unit in the main area in order of the input; and a second display processing unit configured to move, when it is determined that a second number is input following an operator by the input unit, the first number and the operator displayed in the main area to the sub-area, display the first number and the operator in the sub-area, and display the input second number in the main area.

According to another aspect of the present invention, there is provided a computer-readable medium having computer programs stored thereon that, when executed by a computer having a display unit configured to display information and an input unit configured to input a number and an operator, causes the computer to: display a main area and a sub-area on the display unit; display a first number and an operator input by the input unit in the main area in order of the input; and move, when it is determined that a second number is input following an operator by the input unit, the first number and the operator displayed in the main area to the sub-area, display the first number and the operator in the sub-area, and display the input second number in the main area.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a perspective view of a checkout system;

FIG. 2 is a block diagram of hardware configurations of a POS terminal and a barcode scanner;

FIG. 3 is a schematic diagram of data structure of a merchandise master file;

FIG. 4 is a schematic diagram of a detail screen;

FIG. 5 is a flowchart of a flow of processing executed by the POS terminal;

FIG. 6 is a schematic diagram of a state in which a popup screen is displayed on the detail screen;

FIGS. 7A to 7F are schematic diagrams of an example of screen transition of the popup screen; and

FIG. 8 is a schematic diagram of a state in which a payment selection screen is displayed on the detail screen.

### DETAILED DESCRIPTION

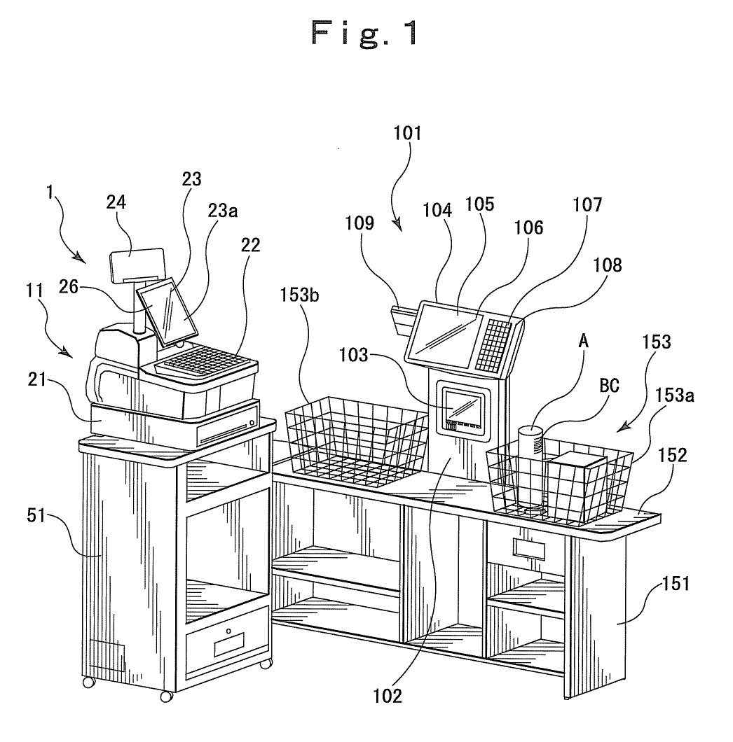

An embodiment of the present invention is explained with reference to FIGS. 1 to 8. This embodiment is an example of application of the present invention to a checkout system 1 installed in a store such as a supermarket.

FIG. 1 is a perspective view of the checkout system 1. The checkout system 1 includes a POS terminal 11 as a commodity sales data processing apparatus. The checkout system 1 also includes a checkout table 51. The POS terminal 11 is placed on the checkout table 51 via a drawer 21. The POS terminal 11 controls opening operation for the drawer 21. A keyboard 22 is arranged on an upper surface of the POS terminal 11. The keyboard 22 is depressed by an operator. In the POS terminal 11, a display device 23 that displays information to the operator, who operates the keyboard 22, is arranged further on an inner side than the keyboard 22 viewed from the operator. The display device 23 displays the information on a display surface 23a. A touch panel 26 is laminated and arranged on the display surface 23a. In the POS terminal 11, a display device for customers 24 that displays information to a customer is vertically provided further on an inner side than the display device 23. A barcode reader 101 as a code reader is connected to the POS terminal 11 to freely transmit and receive data to and from the POS terminal 11.

The barcode reader 101 is set on a counter table 151 of a rectangular table shape. The counter table 151 and the checkout table 51 are arrayed in an L shape. The barcode reader 101 is located in a position on an inner side of a loading surface 152, which is an upper surface of the counter table 151, viewed from the operator.

The loading surface 152 provides a space for placing a shopping basket 153 in which a commodity A is stored. A barcode BC is attached to the commodity A as a code symbol. The shopping basket 153 can be considered to be divided into a first shopping basket 153a carried in to store the commodity A that the customer intends to purchase and a second shopping basket 153b located in a position on the opposite side of the first shopping basket 153a across the barcode reader 101. The first shopping basket 153a and the second shopping basket 153b are respectively located on an upstream side and a downstream side of a flow of customers.

The barcode reader 101 includes a housing 102 of a thin rectangular shape. The housing 102 has an operation unit 104 in an upper part thereof. In the operation unit 104, a display device 106, on a surface of which a touch panel 105 is laminated, is arranged. In the operation unit 104, a keyboard 107, on which plural key tops are arrayed in a matrix shape, is arranged on the right of the display device 106. A card reading groove 108 for a not-shown card reader for reading a magnetic card such as a credit card is prepared on the right of the keyboard 107. Further, a display device for customers 109 for providing the customer with information is set on a left inner side of a rear surface of the operation unit 104 viewed from the operator.

In the housing 102, a reading window 103 is arranged in the front. The commodity A stored in the first shopping basket 153a carried in by the customer is moved to the second shopping basket 153b by the operator. The barcode BC attached to the commodity A is directed to the reading window 103 of the barcode reader 101 in a process for moving the commodity A. Since the barcode reader 101 emits light from an LED (not shown in the figure) arranged on an inner side of the reading window 103, the light from the LED is reflected on the barcode BC and received by a CCD sensor (not shown in the figure) arranged on the inner side of the reading window 103. The barcode reader 101 decodes output of the CCD sensor into a commodity code with a decoding unit (not shown in the figure). In this way, the operator causes the barcode reader 101 to read the commodity code attached to the commodity A as the barcode BC. The commodity code attached to the commodity A is a JAN code, which is a thirteen-digit number, or an in-store code, which is a twenty-six-digit number.

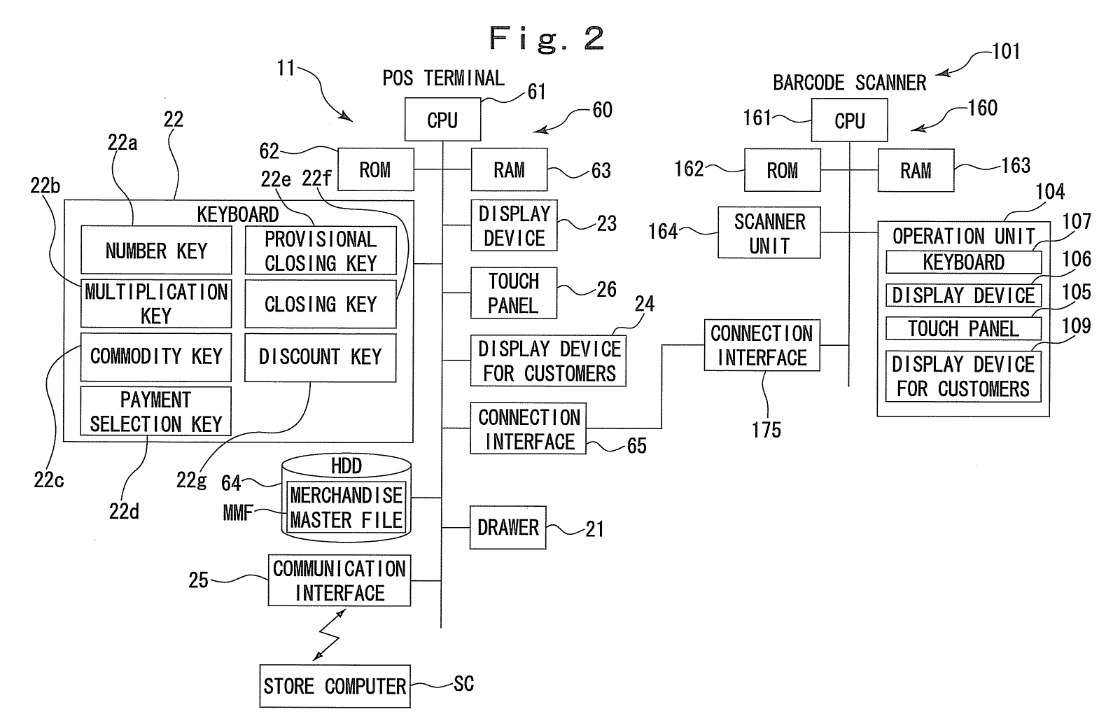

FIG. 2 is a block diagram of hardware configurations of the POS terminal 11 and the barcode reader 101. The POS terminal 11 includes a microcomputer 60 as an information processing unit that executes information processing. The microcomputer 60 includes a CPU 61 that executes various kinds of arithmetic processing and controls the units of the POS terminal 11, a ROM 62 that fixedly stores fixed data such as computer programs, and a RAM 63 that rewritably stores variable data and is used as a work area. The CPU 61, the ROM 62, and the RAM 63 are connected to one another via a bus.

All of the drawer 21, the keyboard 22, the display device 23, the touch panel 26, and the display device for customers 24 are connected to the CPU 61 of the POS terminal 11 via various input and output circuits (all of which are not shown in the figure). The CPU 61 controls these units.

The keyboard 22 includes number keys 22a as input units, on upper surfaces of which numbers “1”, “2”, “3”, and the like are displayed, and a multiplication key 22b as an input unit, on an upper surface of which an operator for multiplication “×” (hereinafter referred to as multiplying operator) is displayed. The number keys 22a and the multiplication key 22b form a so-called ten key. The keyboard 22 includes, besides the ten key, a commodity key 22c, on an upper surface of which a commodity name such as “apple” is displayed, a payment selection key 22d, on an upper surface of which a character string “payment selection” is displayed, a provisional closing key 22e, a closing key 22f, and a discount key 22g on which “discount” is displayed. Functions carried out when the keys of the keyboard 22 are depressed are explained later.

The keys of the keyboard 22 may be provided on the keyboard 107 in the barcode reader 101. The keys of the keyboard 22 may be displayed on the display surface 23a of the display device 23 and touch-designated via the touch panel 26 or may be displayed on a display surface of the display device 106 of the barcode reader 101 and touch-designated via the touch panel 105.

A HDD 64 is connected to the CPU 61 of the POS terminal 11. The HDD 64 stores computer programs and various files. All or a part of the computer programs and the various files stored in the HDD 64 are copied to the RAM 63 and used when the POS terminal 11 is started. An example of the computer programs stored in the HDD 64 is a computer program for commodity sales data processing (not shown in the figure). An example of the files stored in the HDD 64 is a merchandise master file MMF delivered from a store computer SC and stored.

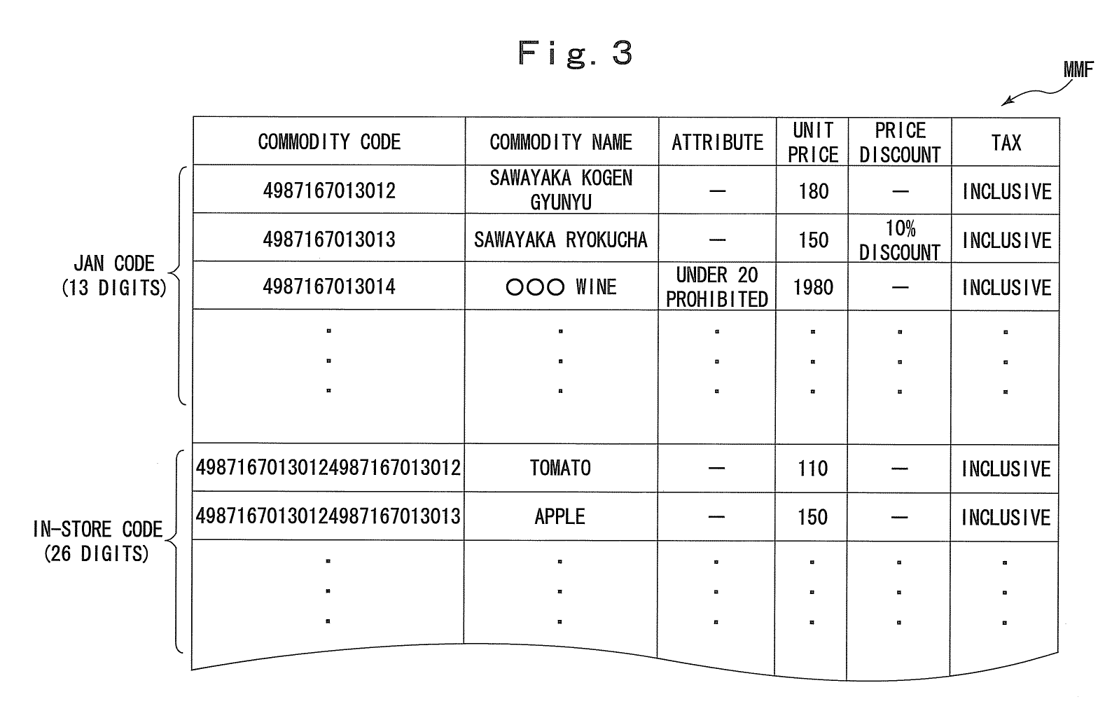

FIG. 3 is a schematic diagram of data structure of the merchandise master file MMF. The merchandise master file MMF is a file that stores, in association with “commodity code”, commodity information of a commodity specified by the commodity code. The “commodity code” is a JAN code, which is a thirteen-digit number, or an in-store code, which is a twenty-six-digit number. The commodity information is “attribute”, “commodity name”, “unit price”, “price discount”, and “tax” concerning the commodity specified by the commodity code. The “attribute” is a commodity attribute of the commodity. For example, when the commodity is a commodity prohibited to be sold to minors, an attribute “under 20 prohibited” is stored. The “commodity name” is a name of the commodity. Commodity names such as “Sawayaka Kogen Gyunyu” and “tomato” are stored. The “unit price” is a unit price of the commodity. Numbers such as “180” and “150” are stored. The “price discount” is information concerning price discount for the “unit price” corresponding thereto. For example, when “10% discount” is stored as the “price discount” in association with the “unit price” of “150 (yen)”, an actual unit price is 135 yen. The “tax” is information concerning whether the “unit price” corresponding thereto is tax inclusive. If the “unit price” is tax inclusive, “inclusive” is stored. In this case, the “unit price” is an amount including a consumption tax.

Referring back to FIG. 2, a communication interface 25 for executing data communication with the store computer SC is connected to the CPU 61 of the POS terminal 11 via an input and output circuit (not shown in the figure). The store computer SC is set in a backyard or the like of the store. A HDD (not shown in the figure) of the store computer SC stores the merchandise master file MMF delivered to the POS terminal 11.

A connection interface 65 that enables data transmission and reception to and from the barcode reader 101 is connected to the CPU 61 of the POS terminal 11. The connection interface 65 is connected to the barcode reader 101.

The barcode reader 101 includes a microcomputer 160 as an information processing unit that executes information processing. The microcomputer 160 includes a CPU 161, a ROM 162, and a RAM 163. The CPU 161, the ROM 162, and the RAM 163 are connected to one another via a bus. The ROM 162 stores computer programs executed by the CPU 161. The operation unit 104 and a scanner unit 164 are connected to the CPU 161 via various input and output circuits (all of which are not shown in the figure). The CPU 161 controls operation of the units. The scanner unit 164 includes a LED control unit that controls operation of an LED, an A/D conversion unit to which the CCD sensor is connected, and a decoding unit (all of which are not shown in the figure). The A/D conversion unit converts an electric signal received from the CCD sensor into a digital signal with an amplifier circuit and a digital conversion circuit. The decoding unit decodes the converted digital signal into a commodity code and outputs the commodity code. A connection interface 175 that is connected to the connection interface 65 of the POS terminal 11 and enables data transmission and reception to and from the POS terminal 11 is connected to the CPU 161.

The CPU 161 of the barcode reader 101 outputs a (decoded) commodity code read by the scanner unit 164 via the connection interface 175 and transmits the commodity code to the POS terminal 11 via the connection interface 65.

When the CPU 61 of the POS terminal 11 determines that a commodity code is input, according to a computer program stored in the ROM 62, the CPU 61 executes commodity sales data processing on the basis of the commodity code determined as being input. Specifically, the CPU 61 of the POS terminal 11 searches through the merchandise master file MMF with the determined commodity code as a key and causes the RAM 63 to store data of commodity information (a commodity name, a unit price, etc.) corresponding to the commodity code. The CPU 61 of the POS terminal 11 executes processing for calculating a total amount based on the unit price stored in the RAM 63. During the execution of the commodity sales data processing, the CPU 61 of the POS terminal 11 controls the display device 23 to display a detail screen AG on the display surface 23a. The CPU 61 controls the display device 23 to display, on the detail screen AG, the commodity information stored in the RAM 63 during the execution of the commodity sales data processing.

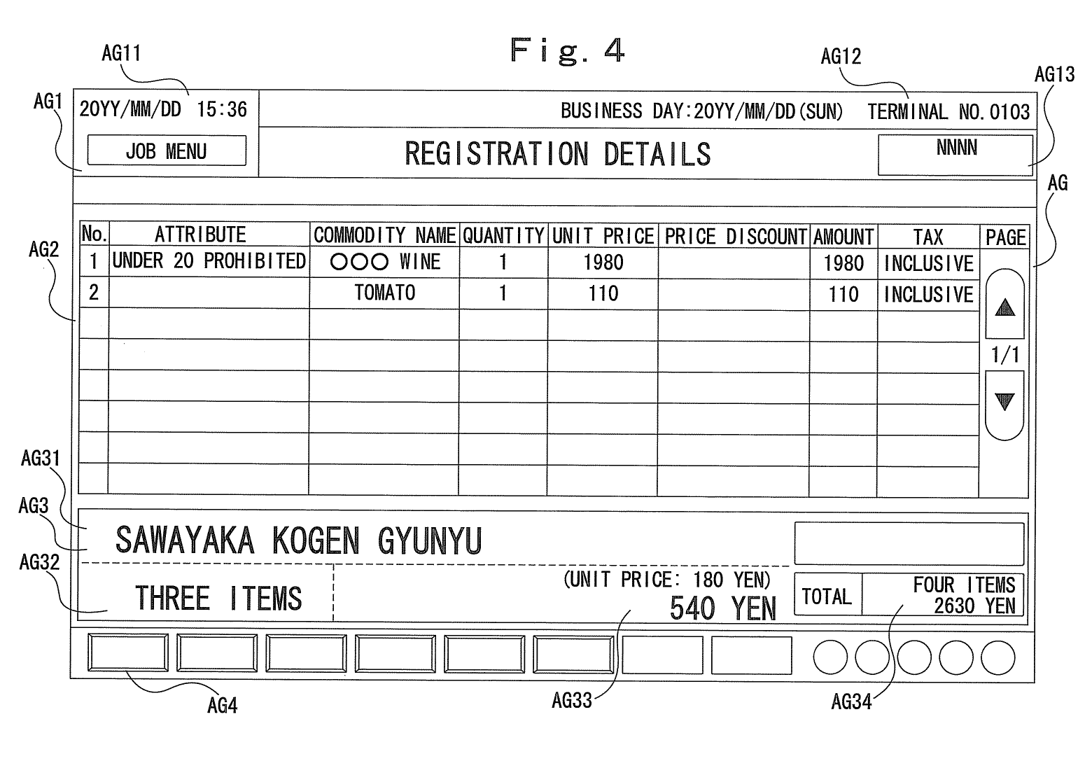

FIG. 4 is a schematic diagram of the detail screen AG. The detail screen AG has plural areas. Specifically, the detail screen AG has a header area AG1, a detail area AG2, a current area AG3, and a footer area AG4 in order from above.

A character string “registration detail” is displayed in the center position of the header area AG1. In the header area AG1, date and time indication AG11 indicating present date and time is displayed at the left end and register number indication AG12 for identifying the POS terminal 11 is displayed at the right end. An operator name display area AG13 in which a name of an operator signing-on the POS terminal 11 is displayed is provided in a position below the register number display AG12.

The CPU 61 of the POS terminal 11 displays the commodity information stored in the RAM 63 during the execution of commodity sales data processing in the detail area AG2 row by row. The detail area AG2 has items “attribute”, “commodity name”, “unit price”, “price discount”, and “tax” for each row to correspond to data items of the merchandise master file MMF. In the detail area AG2, items “No.” as a serial number, “quantity” as a quantity of a commodity input as explained later, and “amount” on which the “price discount” is reflected are prepared. In FIG. 4, the detail area AG2 in which, with the “quantity” set to “1”, commodity codes of “xxx wine” and “tomato” are input in that order is illustrated.

The current area AG3 has a commodity name display area AG31, a quantity display area AG32, an amount display area AG33, and a total quantity and total amount display area AG34. The current area AG3 is explained later.

Plural keys are displayed in the footer area AG4. The CPU 61 of the POS terminal 11 executes functions allocated to the keys when the keys are touch-designated via the touch panel 26. In the following explanation, “the keys displayed on the display surface 23a are touch-designated via the touch panel 26” may be simply referred to as “the keys are depressed”.

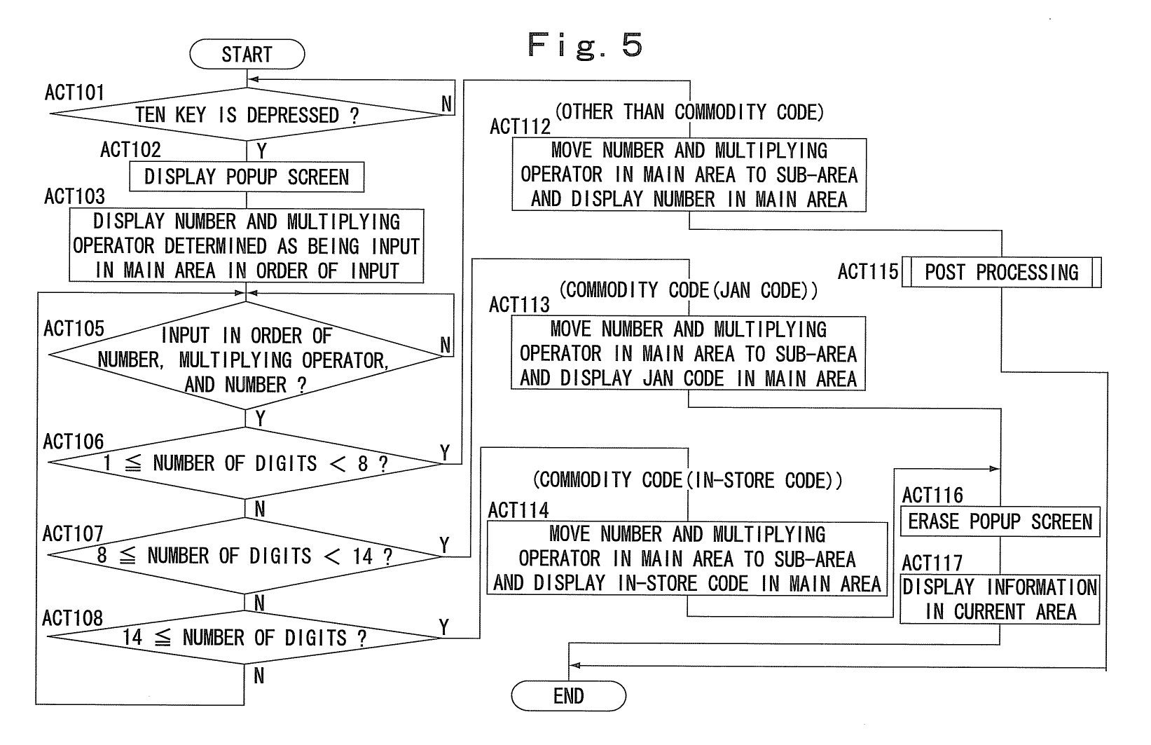

Processing performed when a number is input during display of such a detail screen AG is explained with reference to FIG. 5. The processing explained with reference to FIG. 5 is processing executed by the CPU 61 of the POS terminal 11 according to a computer program stored in the ROM 62.

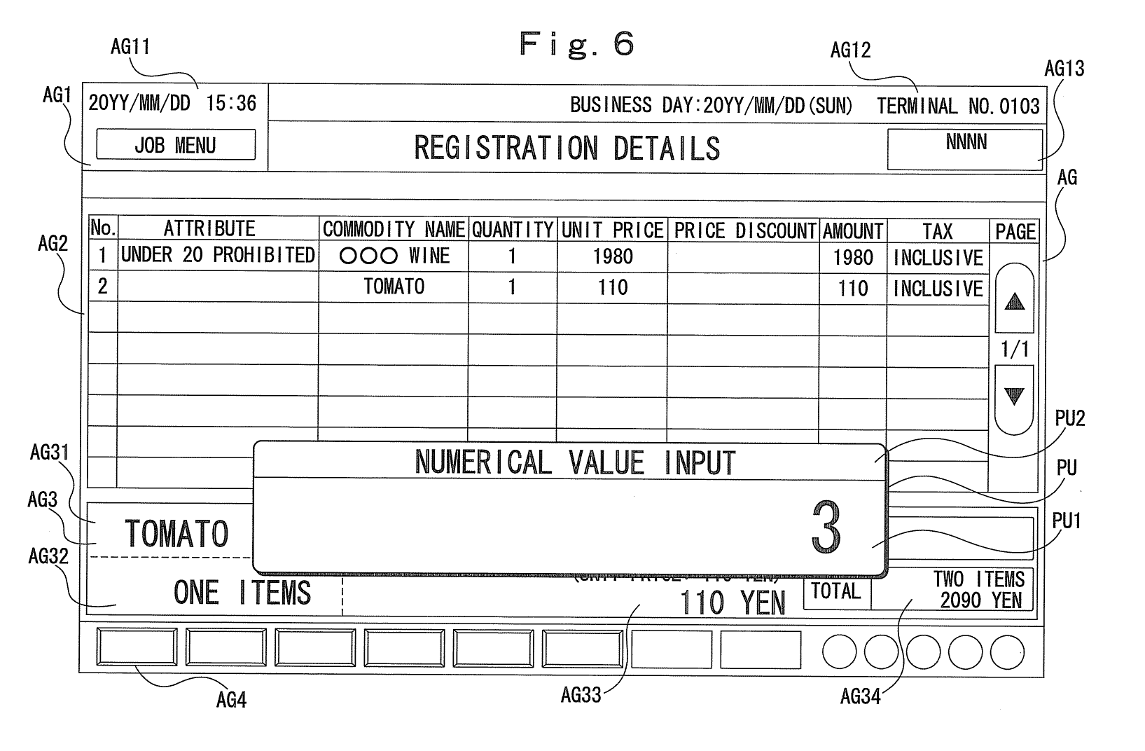

FIG. 5 is a flowchart of a flow of the processing executed by the POS terminal 11. If the ten key (the number key 22a or the multiplication key 22b) is depressed by the operator who operates the POS terminal 11, the CPU 61 of the POS terminal 11 determines that the ten key is depressed (Y in Act 101). The CPU 61 of the POS terminal 11 shows a function of an area-display processing unit according to the determination that the ten key is depressed and controls the display device 23 to popup-display a popup screen PU (see FIG. 6) on the display surface 23a (Act 102).

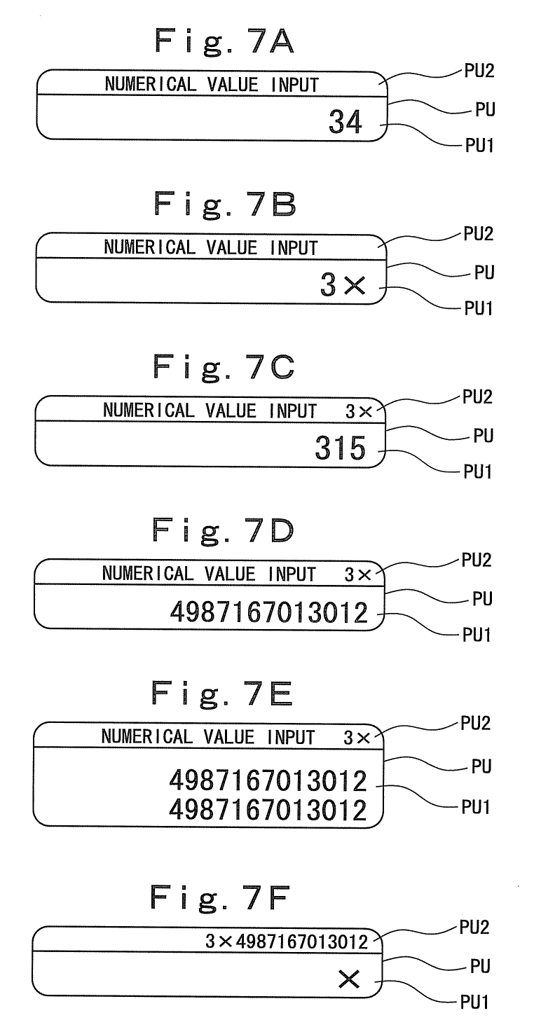

FIG. 6 is a schematic diagram of a state in which the popup screen PU is displayed on the detail screen AG. The popup screen PU is popup-displayed in a position extending over the detail area AG2 and the current area AG3 of the detail screen AG. Therefore, a part of the detail area AG2 and a part of the current area AG3 are hidden by the popup screen PU. The popup screen PU has a two-stage configuration. Specifically, the popup screen PU has a main area PU located at the lower stage in which numbers and signs such as a multiplying operator are displayed and a sub-area PU2 located at the upper stage. The main area PU1 is larger than the sub-area PU2 in the vertical direction. The sub-area PU2 displays a character string “numerical value input” in the center position thereof. However, as explained later, the numbers and the signs such as the multiplying operator are also displayed in the sub-area PU2. In that case, the character string “numerical value input” is erased (see FIG. 7F).

Referring back to FIG. 5, a number displayed on the depressed number key 22a is input according to the depression of the number key 22a as the ten key in Act 101. The multiplying operator “×” is input according to the depression of the multiplication key 22b as the ten key in Act 101. When the CPU 61 of the POS terminal 11 determines that the number or the multiplying operator is input, the CPU 61 causes the RAM 63 to store the number or the multiplying operator determined as being input. The CPU 61 controls the display device 23 to display the number or the multiplying operator determined as being input in the main area PU1 of the popup screen PU displayed on the display surface 23a (Act 103). The popup screen PU illustrated in FIG. 6 is the popup screen PU displayed when the number key 22a “3” is depressed in Act 101. The number “3” is displayed in a position close to the right end of the main area PU1.

After controlling the display device 23 to display the popup screen PU in Act 102, the CPU 61 of the POS terminal 11 shows a function of a first display processing unit and controls the display device 23 to display, in the main area PU1, the number and the multiplying operator determined as being input in Act 101 but also a number and a multiplying operator determined as being input after that in order of the input (Act 103).

FIGS. 7A to 7F are schematic diagrams of an example of screen transition of the popup screen PU. In FIGS. 7A to 7F, the detail screen AG is omitted.

For example, when two number keys 22a are continuously depressed and the CPU 61 of the POS terminal 11 determines that numbers “3” and “4” are input in this order, the CPU 61 controls the display device 23 to display the popup screen PU on which “3” is displayed close to the right end of the main area PU1 (see FIG. 6). Subsequently, the CPU 61 of the POS terminal 11 controls the display device 23 to move “3” to the left side and, as shown in FIG. 7A, display “4” in the position where “3” is initially displayed.

For example, when the number key 22a of “3” and the multiplication key 22b are continuously depressed and the CPU 61 of the POS terminal 11 determines that “3” and “×” are input in this order, the CPU 61 controls the display device 23 to display the popup screen PU on which “3” is displayed close to the right end of the main area PU1 (see FIG. 6). Subsequently, the CPU 61 of the POS terminal 11 controls the display device 23 to move “3” to the left side and, as shown in FIG. 7B, display “×” in the position where “3” is initially displayed.

Referring back to FIG. 5, the CPU 61 of the POS terminal 11 determines that “3” and “×” are input in this order. Therefore, the CPU 61 of the POS terminal 11 displays “3×” in the main area PU1 of the popup screen PU (see FIG. 7B).

If the CPU 61 of the POS terminal 11 determines that a number, a multiplying operator, and a number are input in this order (Y in Act 105), the CPU 61 determines, on the basis of the number of digits of the number determined as being input after the input determination of the multiplying operator (Act 106, Act 107, and Act 108), an attribute of the number input after the multiplying operator.

As an example, if the number of digits of the number determined as being input after the input determination of the multiplying operator in Act 105 is equal to or larger than one and smaller than eight (Y in Act 106), the CPU 61 of the POS terminal 11 determines that the attribute of the input number as “number other than a commodity code”. In this case, the number input is mainly performed according to the depression of the number key 22a. The CPU 61 of the POS terminal 11 controls the display device 23 to display, as shown in FIG. 7C, the number, the attribute of which is determined, in the main area PU1 of the popup screen PU already displayed (Act 112).

As another example, if the number of digits of the number determined as being input after the input determination of the multiplying operator in Act 105 is equal to or larger than eight and smaller than fourteen (N in Act 106 and Y in Act 107), the CPU 61 of the POS terminal 11 determines that an attribute of the input number is “JAN code” as a commodity code. In this case, the number input is mainly performed by reading of the barcode BC by the barcode reader 101. The CPU 61 of the POS terminal 11 controls the display device 23 to display, as shown in FIG. 7D, the number, the attribute of which is determined, in the main area PU1 of the popup screen PU already displayed (Act 113).

As still another example, if the number of digits of the number determined as being input after the input determination of the multiplying operator in Act 105 is equal to or larger than fourteen (N in Act 106, N in Act 107, and Y in Act 108), the CPU 61 of the POS terminal 11 determines that an attribute of the input number is “in-store code” as a commodity code. In this case, the number input is mainly performed according to the depression of the commodity key 22c. Specifically, an in-store code is allocated to the commodity key 22c. The allocated in-store code is input according to the depression of the commodity key 22c. The CPU 61 of the POS terminal 11 controls the display device 23 to display, as shown in FIG. 7E, the number, the attribute of which is determined, in the main area PU1 of the popup screen PU already displayed (Act 114).

As shown in FIGS. 7C, 7D, and 7E, first, the CPU 61 of the POS terminal 11 shows a function of a second display processing unit and controls the display device 23 to move the number “3” and the multiplying operator “×” displayed in the main area PU1 to the sub-area PU2 and display the number “3” and the multiplying operator “×”. The number and the multiplying operator are displayed close to the right end of the sub-area PU2 while the display order thereof in the main area PU1 maintained. The CPU 61 of the POS terminal 11 controls the display device 23 to display the number, the attribute of which is determined, in a position close to the right end of the main area PU1.

The twenty-six-digit in-store code cannot be displayed in one row in the initial main area PU1. Therefore, in Act 114, the CPU 61 of the POS terminal 11 controls the display device 23 to increase, as shown in FIG. 7E, the thickness of the main area PU1 and display the number as the input in-store code in two rows.

After determining that the number input after the input determination of the multiplying operator in Act 105 is the JAN code and controlling the display device 23 to display the number in the main area PU1 of the popup screen PU (Act 113), the CPU 61 of the POS terminal 11 shows a function of an erasing processing unit and controls the display device 23 to erase the popup screen PU from the display surface 23a (Act 116). Similarly, after determining that the number input after the input determination of the multiplying operator in Act 105 is the in-store code and controlling the display device 23 to display the number in the main area PU1 of the popup screen PU (Act 114), the CPU 61 of the POS terminal 11 shows the function of the erasing processing unit and controls the display device 23 to erase the popup screen PU from the display surface 23a (Act 116). In this case, the CPU 61 of the POS terminal 11 determines that the number determined as being input before the input determination of the multiplying operator is “quantity” concerning a commodity specified by a commodity code determined as being input after the input determination of the multiplying operator.

After controlling the display device 23 to erase the popup screen PU (Act 116), the CPU 61 of the POS terminal 11 searches through the merchandise master file MMF with the commodity code (the JAN code or the in-store code), which is determined as being input, as a key and causes the RAM 63 to store data of commodity information (a commodity name and a unit price) corresponding to the commodity code. The CPU 61 of the POS terminal 11 controls the display device 23 to display information (a quantity, commodity information, etc.) stored in the RAM 63 in the current area AG3 of the detail screen AG (Act 117, see FIG. 4 as well).

As an example, three cartons of “Sawayaka Kogen Gyunyu” are purchased. In this case, “3”, “×”, and “4987167013012” (a commodity code of Sawayaka Kogen Gyunyu) are input to the POS terminal 11. The CPU 61 of the POS terminal 11 performs input determination in this order. In the popup screen PU erased in Act 116, as shown in FIG. 7D, “4987167013012” should be displayed in the main area PU1 and “3×” should be displayed in the sub-area PU2. In this case, when the popup screen PU is erased (Act 116), as shown in FIG. 4, a character string “Sawayaka Kogen Gyunyu” is displayed in the commodity name display area AG31 of the current area AG3, “3” is displayed in the quantity display area AG32, and “180” and “540” (=3×180) are displayed in the amount display area AG33. In the total quantity and total amount display area AG34, a total of quantities and a total of unit prices stored in the RAM 63 to that point are calculated and displayed by the CPU 61 of the POS terminal 11. The information display in the current area AG3 is performed until another kind of information display is provided to the current area AG3.

As explained above, the popup screen PU is erased after the commodity code is displayed in the main area PU1 (Act 113 and Act 114) (Act 116). In some case, price discount is applied to a unit price specified by the commodity code. For example, when 10% discount is applied, the operator continuously inputs “×”, “10”, and “discount instruction” to the POS terminal 11. Specifically, first, the operator depresses the multiplication key 22b and inputs the multiplying operator “×” to the POS terminal 11. The CPU 61 of the POS terminal 11 controls, according to the input determination of the multiplying operator, the display device 23 to popup-display the popup screen PU on which “×” is displayed at the right end of the main area PU1 (Act 101 to Act 103). The CPU 61 of the POS terminal 11 controls the display device 23 to revive and display, in the sub-area PU2 of the popup screen PU to be popup-displayed, the information displayed on the popup screen PU erased immediately before the popup display. A screen example of the popup screen PU is shown in FIG. 7F. The information displayed on the popup screen PU erased immediately before the popup display, which is information to be displayed in the sub-area PU2 of the new popup screen PU, is, as an example, the quantity “3”, the multiplying operator “×”, and the JAN code “4987167013012”. These kinds of information are stored in the RAM 63. The CPU 61 of the POS terminal 11 controls, on the basis of the information stored in the RAM 63, the display device 23 to display information in the sub-area PU2 of the new popup screen PU.

Subsequently, the operator depresses the number key 22a to input a number “10”. “×10” is displayed in the main area PU1 of the popup screen PU (Act 103). The operator depresses the discount key 22g. Consequently, a discount instruction is input to the POS terminal 11. The CPU 61 of the POS terminal 11 executes, according to determination that the discount instruction is input, 10% discount processing for a unit price specified by the commodity code input before the multiplying operator “×”, which is the commodity code displayed in the sub-area PU2. The CPU 61 of the POS terminal 11 regards the input determination of the discount instruction as input determination of an erasing instruction. Therefore, the CPU 61 of the POS terminal 11 controls the display device 23 to erase the popup screen PU after the input determination of the discount instruction. The CPU 61 of the POS terminal 11 controls the display device 23 to display commodity information in the current area AG3. When the commodity information is displayed, a unit price calculated by the 10% discount processing is displayed in the amount display area AG33.

The CPU 61 of the POS terminal 11 determines that the number determined as being input after the input determination of the multiplying operator in Act 105 is other than the commodity code and controls the display device 23 to display the number in the main area PU1 of the popup screen PU (Act 112). In this case, the CPU 61 of the POS terminal 11 controls the display device 23 to continue to display the popup screen PU without erasing the same and executes post processing (Act 115). In an example of such processing, the commodity A, the barcode BC of which cannot be read by the barcode reader 101 because of some reason, is discounted 10%. In this case, first, the operator inputs a commodity code (a JAN code) indicated by the barcode BC of the commodity A by depressing the number keys 22a. Then, the operator inputs the multiplying operator by depressing the multiplication key 22b (Act 101 to Act 103). Subsequently, the operator inputs “10” indicating 10% discount by depressing the number keys 22a (Y in Act 105 and Y in Act 106). When “10” is input, “thirteen digit number equivalent to the commodity code” and “×” are displayed in the sub-area PU2 of the popup screen PU and “10” is displayed in the main area PU1 (Act 112). This popup screen PU is not erased. In the post processing in Act 115 after that, the operator depresses the discount key 22g. According to the depression of the discount key 22g, a discount instruction is input to the POS terminal 11. According to determination of the input of the discount instruction, the CPU 61 of the POS terminal 11 executes 10% discount processing for a unit price specified by the commodity code input before the multiplying operator “×”. The CPU 61 of the POS terminal 11 regards the input determination of the discount instruction as input determination of an erasing instruction. Therefore, the CPU 61 of the POS terminal 11 controls the display device 23 to erase the popup screen PU after the input determination of the discount instruction. The CPU 61 of the POS terminal 11 controls the display device 23 to display commodity information in the current area AG3. When the commodity information is displayed, a unit price calculated by the 10% discount processing is displayed in the amount display area AG33.

When the reading of the barcode BC and the like concerning all the commodities A stored in the first shopping basket 153a end, the operator of the POS terminal 11 depresses the provisional closing key 22e. When the provisional closing key 22e is depressed, the CPU 61 of the POS terminal 11 controls the display device 23 to popup-display a payment screen (not shown in the figure) on the detail screen AG. When the payment screen is popup-displayed, according to the depression of the provisional closing key 22e, the CPU 61 of the POS terminal 11 calculates, on the basis of the unit price stored in the RAM 63, a total amount that the customer should pay and causes the RAM 63 to store the calculated total amount. Therefore, the total amount stored in the RAM 63 is displayed on the payment screen. The total amount displayed on the payment screen is also displayed on the display device for customers 24. The customer who looks at the total amount displayed on the display device for customers 24 deposits cash equivalent to an amount equal to or larger than the total amount with the operator. The operator inputs a number equivalent to the deposited cash amount to the POS terminal 11 with depressing operation for the number keys 22a. When the number is input, the closing key 22f is depressed to decide the input amount. The CPU 61 of the POS terminal 11 causes the RAM 63 to store the input number as the deposit amount and controls the display device 23 to display the number on the payment screen. Further, the CPU 61 of the POS terminal 11 calculates a balance when the deposit amount is equal to or larger than the total amount, causes the RAM 63 to store the calculated balance as a change amount, and controls the display device 23 to display the balance on the payment screen.

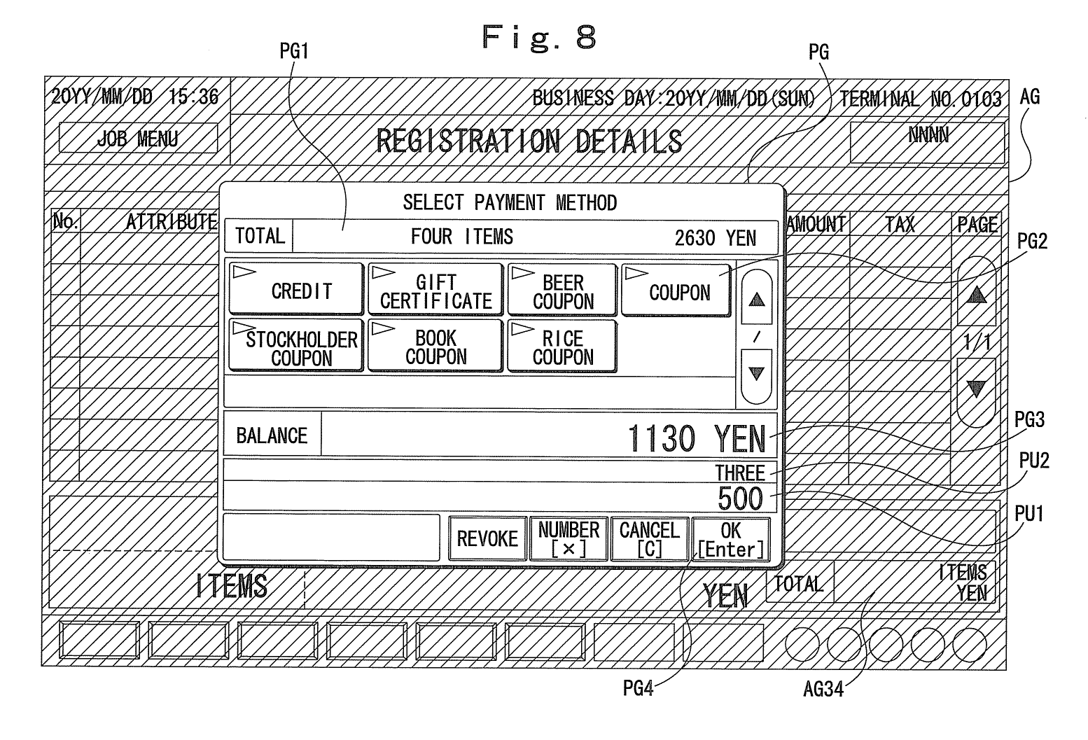

Some customer desires to pay a part or all of a total amount as a note such as a gift certificate rather than cash. The operator who is informed to that effect by the customer depresses the payment selection key 22d after the provisional closing key 22e is depressed and the payment screen (not shown in the figure) is displayed. When the payment selection key 22d is depressed, a display instruction for a payment selection screen PG (see FIG. 8) is input to the POS terminal 11. The CPU 61 of the POS terminal 11 controls the display device 23 to popup-display the payment selection screen PG on the detail screen AG according to input determination of the display instruction.

FIG. 8 is a schematic diagram of a state in which the payment selection screen PG is displayed on the detail screen AG. The payment selection screen PG is a screen having a rectangular shape smaller than the detail screen AG. As shown in FIG. 8, in a state in which the payment selection screen PG is displayed, the detail screen AG is grayed out. When the detail screen AG is grayed out, touch designation of the keys in the footer area AG4 of the detail screen AG via the touch panel 26 is invalid.

As shown in FIG. 8, the payment selection screen PG has a total amount display area PG1 in which the total amount stored in the RAM 63 is displayed. Plural note keys PG2 are arranged in an area below the total amount display area PG1. “Gift certificate”, “beer coupon”, and the like are displayed on upper surfaces of the note keys PG2. A balance display area PG3 explained later is provided in an area below the note keys PG2. Like the popup screen PU, the payment selection screen PG has the main area PU1 and the sub-area PU2 in an area below the balance display area PG3.

In a state in which the payment selection screen PG is displayed, processing same as the processing explained with reference to the flowchart of FIG. 5 is executed. First, the number of notes (e.g., “3”) is input according to depression of the number key 22a by the operator. When the CPU 61 of the POS terminal 11 determines that a number equivalent to the number of notes is input, the CPU 61 controls the display device 23 to display the number determined as being input in the main area PU1 of the payment selection screen PG (Act 103). The popup screen PU is not displayed. When the multiplication key 22b is depressed and the CPU 61 of the POS terminal 11 determines that a multiplying operator is input, the CPU 61 controls the display device 23 to move the number of notes displayed in the main area PU1 of the payment selection screen PG to the left side and display, rather than “×”, “number of notes” as a multiplying operator in a position where this number is initially displayed (Act 103). After the input of the multiplying operator, the operator inputs a face value of the notes (e.g., “500”) with the number keys 22a (Act 105). Since the number of digits of an input number is smaller than eight (Y in Act 106), the CPU 61 of the POS terminal 11 determines that the number is a face value of notes other than a commodity code. The CPU 61 of the POS terminal 11 controls the display device 23 to display the number, the attribute of which is determined, in the main area PU1 of the payment selection screen PG (Act 112). When the number is displayed, first, the CPU 61 of the POS terminal 11 controls the display device 23 to move the number “3” and the multiplying operator “number of notes” displayed in the main area PU1 to the sub-area PU2 and display the number “3” and the multiplying operator “number of notes”. The number and the multiplying operator (“3 notes”) are displayed close to the right end of the sub-area PU2 while the display order in the main area PU1 maintained. The CPU 61 of the POS terminal 11 controls the display device 23 to display the number “500”, the attribute of which is determined, in a position close to the right end of the main area PU1 (see FIG. 8).

In the post processing after that (Act 115), the multiplication key 22b and the note key PG2 are continuously depressed. According to the depression of the note key PG2, on which “gift certificate” is displayed, an instruction for payment by the gift certificate is input to the POS terminal 11. When the CPU 61 of the POS terminal 11 continuously determines that multiplying operator is input and the instruction for payment by the gift certificate is input, the CPU 61 calculates, as a note amount, a number obtained by multiplying together the number as the number of notes determined as being input before the input determination of the multiplying operator and the number as the note face value determined as being input after the input determination of the multiplying operator. The CPU 61 of the POS terminal 11 calculates, as a balance, an amount obtained by subtracting the note amount from the total amount displayed in the total amount display area PG1, causes the RAM 63 to store the amount, and controls the display device 23 to display the amount in the balance display area PG3 of the payment selection screen PG. When a determination key PG4, on which “OK” is displayed, of the payment selection screen PG is depressed, the payment selection screen PG is erased and the payment screen (not shown in the figure) is displayed. The balance is displayed on the payment screen. The customer deposits cash equivalent to the balance with the operator of the POS terminal 11. The operator inputs a number equivalent to the deposited cash amount to the POS terminal 11 according to depressing operation for the number keys 22a. The CPU 61 of the POS terminal 11 controls the display device 23 to display the input number on the payment screen as a deposit amount. When the deposit amount is equal to or larger than the total amount, the CPU 61 of the POS terminal 11 calculates a balance as a change amount and controls the display device 23 to display the balance on the payment screen. The payment selection screen PG is erased. When the payment screen (not shown in the figure) is displayed, if the balance is minus, a change amount is calculated and displayed on the payment screen. If the balance is zero, the processing ends.

As explained above, according to this embodiment, a number and a multiplying operator are displayed in the main area PU1 and the sub-area PU2 in input order thereof. When a number is input after the input of the multiplying operator, the number and the multiplying operator displayed in the main area PU1 are moved to the sub-area PU2 and a number determined as being input anew is displayed in the main area PU1. Consequently, the operator of the POS terminal 11 can check an input process performed by the operator. When the operator forgets to input the multiplying operator, the movement of display is not performed. Therefore, the operator easily notices, in particular, an input mistake of an operator. In this way, the operator of the POS terminal 11 can find an input mistake earlier.

In this embodiment, the popup screen PU including the main area PU1 and the sub-area PU2 is displayed according to the depression of the ten key. In the popup screen PU, it is easy to visually distinguish the main area PU1 and the sub-area PU2 from the other display elements (the detail screen AG, etc.) in the display surface 23a of the display device 23. Consequently, the operator can clearly check an input process.

Obviously, numerous modifications and variations of the present invention are possible in light of the above teachings. It is therefore to be understood that within the scope of the appended claims, the invention may be practiced otherwise than as specifically described herein.

What is claimed is:

1. A commodity sales data processing apparatus comprising:
a display unit configured to display information;
an input unit configured to input a number and an operator;
an area-display processing unit configured to display a main area and a sub-area on the display unit;
a first display processing unit configured to display a first number and an operator input by the input unit in the main area in order of the input; and
a second display processing unit configured to move, when it is determined that a second number is input following an operator by the input unit, the first number and the operator displayed in the main area to the sub-area, display the first number and the operator in the sub-area, and display the input second number in the main area.

2. The apparatus of claim 1, wherein the area-display processing unit popup-displays the main area and the sub-area.

3. The apparatus of claim 2, further comprising an erasing processing unit configured to erase the popup screen when it is determined that the second number input following the operator by the input unit is a commodity code.

4. The apparatus of claim 1, wherein the input unit includes a code reader that optically reads a commodity code, which is a plural-digit number described in a form of a code symbol.

5. The apparatus of claim 1, wherein the input unit includes a commodity key for inputting a commodity code, which is a plural-digit number.

6. A computer-readable medium having computer programs stored thereon that, when executed by a computer having a display unit configured to display information and an input unit configured to input a number and an operator, causes the computer to:
display a main area and a sub-area on the display unit;
display a first number and an operator input by the input unit in the main area in order of the input; and
move, when it is determined that a second number is input following an operator by the input unit, the first number and the operator displayed in the main area to the sub-area, display the first number and the operator in the sub-area, and display the input second number in the main area.

7. The medium of claim 6, wherein the main area and the sub-area are popup-displayed.

8. The medium of claim 7, wherein the computer program further causes the computer to erase the popup screen when it is determined that the number input following the operator by the input unit is a commodity code.
